(19) United States
(12) Patent Application Publication
(10) Pub. No.: US 2012/0228568 A1
(43) Pub. Date: Sep. 13, 2012

(54) Nail/Bolt Slide Hammer Extractor

(76) Inventor: Joseph Alfred Leon, Bakersfield, CA (US)

(21) Appl. No.: 13/044,837

(22) Filed: Mar. 10, 2011

(51) Int. Cl. B25C 11/00; B23P 11/00

(52) U.S. Cl. 254/21; 29/426.5

(57) ABSTRACT

Disclosed and described herein is a hand held nail and bolt extractor, to pry up unexposed headed-nails or bolts from substrates and extract exposed headed-nails or bolts from substrates. The tool has a cleft claw at the bottom end, a hand gripped weighted slide hammer, a shaft with stop points at top and bottom of the shaft, an outward tapper at the bottom stop of the shaft, or a magnetic washer at the bottom stop of the shaft, or a soft lock bearing in the slide hammer that will pop into a grove at the bottom stop of the shaft, to maintain a temporary stay position on said hand gripped weighed slide hammer. At the top end is a tapered flat end pry with a center cleft. Made of metal and partially coated with rubber or plastic on the hand gripped weighted slide hammer. The slide hammer when used properly will cause an impact at the top stop of the shaft, which will then transfer compounded exertion force to either pull or pry the object that is to be removed.

### CROSS-REFERENCE TO RELATED APPLICATION

| | | |
|---|---|---|
| 4,815,707 | March 1989 | Brown |
| 4,997,163 | March 1991 | Henning |
| 5,984,272 | November 1999 | Crider |
| 6,105,935 | August 2000 | Wagner |
| 6,910,252 | June 2005 | Draggie, et al. |
| 7,140,087 | November 2006 | Glitner |
| 7,658,368 | February 2010 | Laun |

### BACKGROUND OF THE INVENTION

The present invention is directed toward tools and hardware; more particularly a tool which extracts headed-nails or bolts from a substrate. More specifically, it relates to a device for the ease of extracting a headed-nail or bolt, without having to leverage against the substrate. When a headed-nail or bolt is not exposed, the invention has a flat end pry with a cleft to assist in exposing headed-nails or bolts. Once the exposed headed-nail or bolt is out enough, then the cleft claw at the bottom of the invention can hook the headed-nail or bolt to be extracted. The hand gripped weighted slide hammer is used as a ramming component to hit the top stop creating a compounded impact to force pressure on the claw component of said invention causing a pulling effect or a wedging effect on the tapered flat end pry with the center cleft.

### BRIEF SUMMARY OF THE INVENTION

In accordance with the characteristics of the invention, one could see that the extraction devices are common to existing uses for extracting headed-nails, with the exception of the cleverness and relevance of the hand gripped weighted slide hammer. When properly used this invention can easily extract headed-nails, without having to pry against an existing substrate. Extraction by prying , could cause damage to roof tiles, cabinets and other finished components. The hand held tool, allows a free hand to lift roof tiles, for ease of removal. When headed-nails are nailed at an angle, it is very difficult to extract same unless pulling occurs rather than prying.

### DETAILED DESCRIPTION OF THE INVENTION

The nail/bolt slide hammer extractor described herein is primarily made of steel, with rubber or plastic coating around the hand gripped weighted slide hammer. The cleft claw, shaft, tapered flat end pry with a center cleft and the top and bottom stops are one solid piece. The hand gripped weighted slide hammer is barreled around the shaft portion of this tool, and can easily slide between the top and bottom stops. The extractor can be made to handle small headed nails as needed in a shoe cobblers shop or as big as needed to extract bolts in an industrial setting. The weight of the slide hammer will depend on the end users requirements. The solid one piece with the cleft claw , shaft, and cleft flat end pry would typically be made from round, square, hexagon, or octagon steel bar stock.

### BRIEF DESCRIPTION OF THE SEVERAL VIEWS OF THE DRAWING

FIG. 1 Complete Nail/Bolt Slide Hammer Extractor.

FIG. 2 Top portion of the shaft.

FIG. 3 Outward taper of the bottom end of the slide shaft.

FIG. 4 Tapered flat end pry with a cleft center.

FIG. 5 Claw with a center cleft.

FIG. 6 Top stop on the slide shaft.

FIG. 7 Rubber or plastic exterior of the hand gripped weighted slide hammer

FIG. 8 Bottom stop on the slide shaft.

FIG. 9 Barreled metal weighted slide hammer.

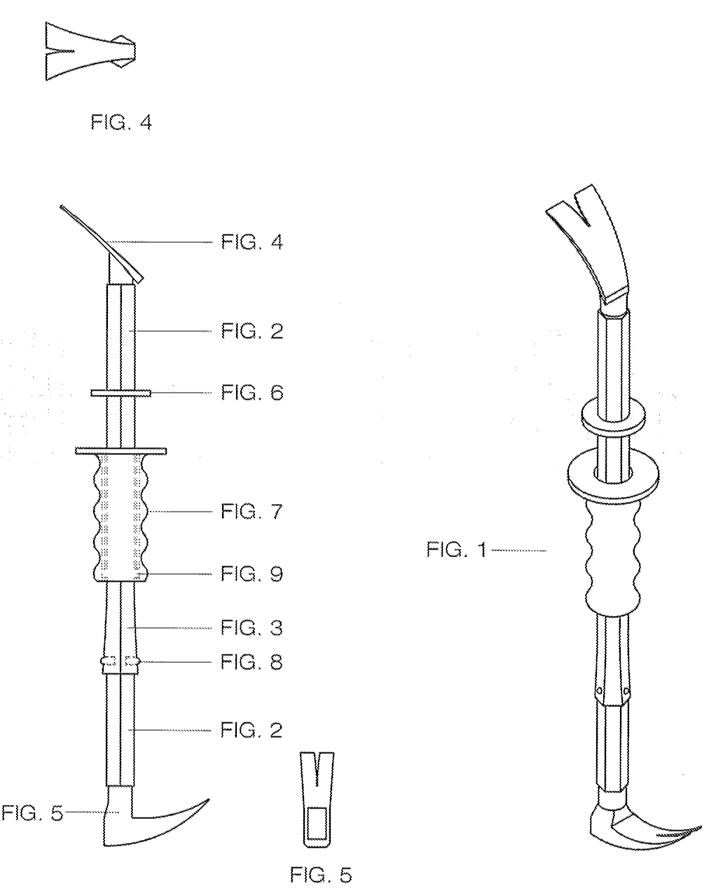

1. A hand held nail or bolt extractor, used to pry up unexposed headed-nails or bolts from substrates and extract exposed headed-nails or bolts from substrates. The invention has a cleft claw at he bottom end, a hand gripped weighted slide hammer, a shaft with stop points at the top and bottom of the shaft, an outward tapper at the bottom of the shaft or a magnetic washer at the bottom stop of shaft or a soft lock bearing in the slide hammer that will pop into a grove within the shaft at the bottom stop of the shaft, to maintain a temporary stay position on said hand gripped weighted slide hammer. At the top end is a tapered flat end pry with a center cleft. Said invention would be made of metal and partially coated with rubber or plastic on the hand gripped weighted slide hammer portion, and at the bottom stop if a magnetic washer is used.

2. A method of extracting a partially exposed headed-nail or bolt from a substrate By hooking the headed nail or bolt with the cleft claw and then actuating the hand gripped weighted slide hammer by physical force in a swift movement toward the top stop. The slide hammer when properly used will cause an impact at the top stop of the shaft, which will then transfer compounded exerted force to pull the object being extracted from a substrate.

3. A method of prying up an unexposed headed nail or bolt by using the top end tapered flat pry with a center cleft by forcing the hand gripped weighted slide hammer against the top stop, to pry up unexposed headed nail or bolt. Then hook the exposed headed-nail or bolt with the cleft claw for extraction from a substrate.

4. A method of creating an impact at the top stop of the shaft by physical force to transfer compounded exertion force by use of the hand gripped weighted slide hammer as the impact denominator to either pull or pry the object that is to be extracted from a substrate.

5. A method of using a single hand tool, left handed or right handed to extract headed nails or bolts from a substrate.

6. A method of extracting angled nailed or toe nailed nails from a substrate without having to pry against the substrate.

7. A method of extracting headed nails from tiled roofs without having to pry against breakable roof tiles.

8. A single inventive concept.
